(19) United States
(12) Patent Application Publication
(10) Pub. No.: US 2023/0332589 A1
(43) Pub. Date: Oct. 19, 2023

(54) PACKAGED COMPRESSOR

(71) Applicant: HITACHI INDUSTRIAL EQUIPMENT SYSTEMS CO., LTD., Tokyo (JP)

(72) Inventors: Kentaro YAMAMOTO, Tokyo (JP); Tomoyuki KADO, Tokyo (JP)

(21) Appl. No.: 18/026,258

(22) PCT Filed: Sep. 21, 2021
(86) PCT No.: PCT/JP2021/034542

§ 371 Date: Mar. 14, 2023

(30) Foreign Application Priority Data
Sep. 23, 2020 (JP) 2020-158273

(51) Int. Cl. F04B 39/06; F04B 39/16; F04B 17/03

(52) U.S. Cl. CPC F04B 39/066; F04B 39/16; F04B 17/03; F04B 39/023

(57) ABSTRACT

A packaged compressor with enhanced electric motor coolability includes an electric motor having an axial direction that lies in a horizontal direction; a compressor body; a housing that houses the electric motor and the compressor body; a cooling air inlet formed through a side surface of the housing; a cooling air outlet formed through an upper surface of the housing; and a cooling fan arranged on a side of the electric motor such that an axial direction of the cooling fan lies in a horizontal direction and crosses the axial direction of the electric motor. The cooling fan has a diameter greater than the height dimension of the electric motor and it's its axial-direction projection plane includes a portion overlapping the electric motor, a portion positioned above the electric motor and not overlapping the electric motor, and a portion positioned below the electric motor and not overlapping the electric motor.

### TECHNICAL FIELD

The present invention relates to a packaged compressor.

### BACKGROUND ART

A packaged compressor in Patent Document 1 includes: an electric motor having an axial direction that lies in the horizontal direction; a compressor body that is driven by the electric motor and compresses a gas; a housing that houses the electric motor and the compressor body; a cooling air inlet formed through a side surface of the housing; a cooling air outlet formed through the upper surface of the housing; and a cooling fan that is arranged on a side of the electric motor such that the axial direction of the cooling fan lies in the horizontal direction and crosses the axial direction of the electric motor. The cooling fan induces a flow of cooling air that flows in from the outside of the housing via the cooling air inlet, thereafter flows around the electric motor, and thereafter flows out to the outside of the housing via the cooling air outlet.

### PRIOR ART DOCUMENT

### Patent Document

Patent Document 1: JP-2006-112353-A

### SUMMARY OF THE INVENTION

### Problem to be Solved by the Invention

The cooling fan in Patent Document 1 is configured such that its diameter is smaller than the height dimension of the electric motor. In addition, the cooling fan in Patent Document 1 is arranged such that its axial-direction projection plane includes a portion overlapping the electric motor, and a portion positioned above the electric motor and not overlapping the electric motor, but does not include a portion positioned below the electric motor and not overlapping the electric motor. Accordingly, the flow rate of the cooling air flowing along an upper portion of the electric motor increases, but the flow rate of the cooling air flowing along a lower portion of the electric motor decreases. Therefore, there is room for improvement in terms of electric-motor coolability.

The present invention has been made in view of matters described above, and one of objects thereof is to enhance electric-motor coolability.

### Means for Solving the Problem

In order to solve the problem described above, configuration described in claims is applied. The present invention includes a plurality of means for solving the problem described above, and an example thereof is a packaged compressor including: an electric motor having an axial direction that lies in a horizontal direction; a compressor body that is driven by the electric motor, and compresses a gas; a housing that houses the electric motor and the compressor body; a cooling air inlet formed through a side surface of the housing; a cooling air outlet formed through an upper surface of the housing; and a cooling fan that is arranged on a side of the electric motor such that an axial direction of the cooling fan lies in a horizontal direction and crosses the axial direction of the electric motor, the cooling fan inducing a flow of cooling air that flows in from an outside of the housing via the cooling air inlet, thereafter flows around the electric motor, and thereafter flows out to the outside of the housing via the cooling air outlet, in which the cooling fan is configured such that a diameter of the cooling fan is greater than a height dimension of the electric motor, and additionally is arranged such that an axial-direction projection plane of the cooling fan includes a portion overlapping the electric motor, a portion positioned above the electric motor and not overlapping the electric motor, and a portion positioned below the electric motor and not overlapping the electric motor.

### Advantage of the Invention

According to the present invention, electric-motor coolability can be enhanced.

Note that problems, configuration, and advantages other than those described above are made clear by the following explanation.

### BRIEF DESCRIPTION OF THE DRAWINGS

FIG. 1 is a front-side transparent view representing the structure of main portions of a packaged compressor according to a first embodiment of the present invention.

FIG. 2 is a left-side transparent view representing the structure of main portions of the packaged compressor according to the first embodiment of the present invention.

FIG. 3 is a cross-sectional view taken along a plane represented by arrows III-III in FIG. 1.

FIG. 4 is a cross-sectional view representing the internal structure of an electric motor and a compressor body according to the first embodiment of the present invention.

FIG. 5 is a front-side transparent view representing the structure of main portions of a packaged compressor according to a second embodiment of the present invention.

FIG. 6 is a left-side transparent view representing the structure of main portions of the packaged compressor according to the second embodiment of the present invention.

FIG. 7 is a cross-sectional view taken along a plane represented by arrows VII-VII in FIG. 5.

FIG. 8 is a left-side transparent view representing the structure of main portions of a packaged compressor according to a modification example of the present invention.

### MODES FOR CARRYING OUT THE INVENTION

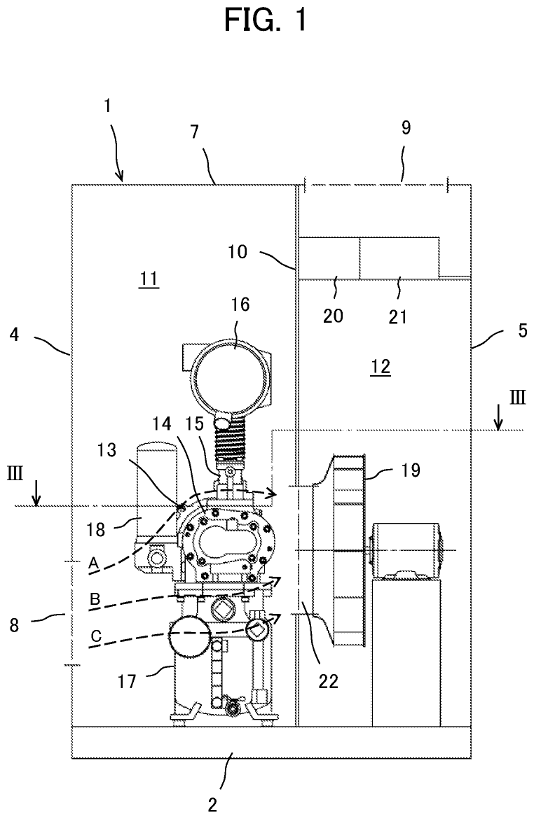

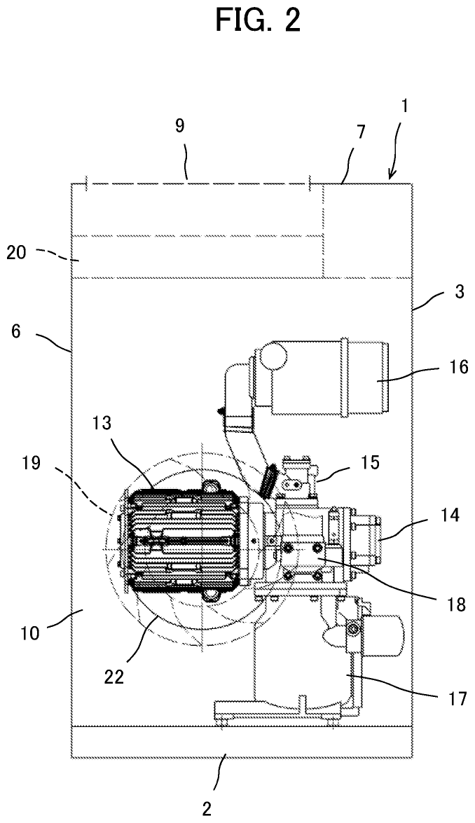

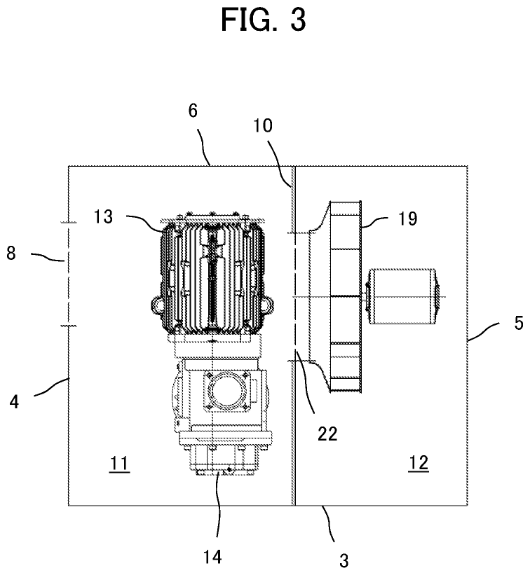

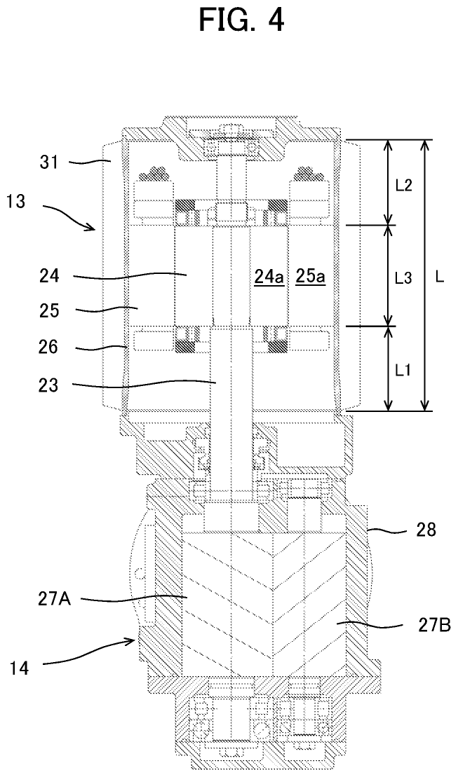

A first embodiment of the present invention is explained by using FIG. 1 to FIG. 4. FIG. 1 is a front-side transparent view representing the structure of main portions of a packaged compressor according to the present embodiment. FIG. 2 is a left-side transparent view representing the structure of main portions of the packaged compressor according to the present embodiment. FIG. 3 is a cross-sectional view taken along a plane represented by arrows III-III in FIG. 1. FIG. 4 is a cross-sectional view representing the internal structure of an electric motor and a compressor body according to the present embodiment.

The packaged compressor according to the present embodiment includes a housing 1 that houses equipment and components mentioned later. The housing 1 includes a base plate 2, a front side plate 3, a left side plate 4, a right side plate 5, a rear side plate 6, and a top plate 7. A cooling air inlet 8 is formed through the left side plate 4, and a cooling air outlet 9 is formed through the top plate 7. Note that the front side plate 3 is detachable such that inspection work or the like of equipment in the housing 1 can be performed.

Inside the housing 1, a machine room 11 and a fan duct 12 that are separated from each other by a partition plate 10 are formed. The machine room 11 houses an electric motor 13, a compressor body 14, a suction throttle valve 15, a suction filter 16, a separator 17, and a separation filter 18.

The fan duct 12 includes the partition plate 10, part of the base plate 2, part of the front side plate 3, the right side plate 5, part of the rear side plate 6, and part of the top plate 7. The fan duct 12 houses a cooling fan 19, an oil cooler 20 (heat exchanger), and an aftercooler 21 (heat exchanger). A vent 22 is formed through the partition plate 10 at a position at which the cooling fan 19 faces.

The electric motor 13 includes: a rotation shaft 23 extending in the horizontal direction (the left-right direction in FIG. 2, and the up-down direction in FIG. 3 and FIG. 4); a rotor 24 attached to the rotation shaft 23; a stator 25 arranged apart from and on the outer-circumference side of the rotor 24; a casing 26 to which the stator 25 is attached; and a plurality of fins 31 formed outside the casing 26 and extending in the axial direction. A rotating magnetic field generated by the rotor 24 and the stator 25 rotates the rotation shaft 23.

The compressor body 14 includes a pair of female and male screw rotors 27A and 27B that mesh with each other, and a casing 28 housing them. The compressor body 14 is coupled to one axial side of the electric motor 13 (the right side in FIG. 2, and the lower side in FIG. 3 and FIG. 4), and forms a compressor unit together with the electric motor 13. Explaining specifically, the casing 28 of the compressor body 14 is coupled with the casing 26 of the electric motor 13. In addition, the screw rotor 27A of the compressor body 14 is coupled with the rotation shaft 23 of the electric motor 13. Thereby, the screw rotors 27A and 27B rotate.

A plurality of compression chambers are formed between grooves of the screw rotors 27A and 27B. Along with rotation of the screw rotors 27A and 27B, each compression chamber moves in the axial directions of the screw rotors 27A and 27B (in the present embodiment, a direction away from the electric motor 13, the rightward direction in FIG. 2, and the downward direction in FIG. 3 and FIG. 4), and also sequentially performs a suction process of sucking in air (gas), a compression process of compressing the air, and a delivery process of delivering the compressed air (compressed gas). For the purpose of sealing the compression chambers, cooling compression heat, lubricating the rotors, and so on, the compressor body 14 is configured to inject an oil (liquid) to the compression chambers.

The suction throttle valve 15 is coupled to the suction side (upper side) of the compressor body 14, and the suction filter 16 is connected to the upstream side of the suction throttle valve 15 via a pipe. The separator 17 is coupled to the delivery side (lower side) of the compressor body 14, and also installed on the base plate 2. The separator 17 performs primary separation of the oil from the compressed air delivered from the compressor body 14, and stores the separated oil.

The oil stored in the separator 17 is supplied to the compression chambers of the compressor body 14 and the like via an oil system (liquid system). The oil system has the oil cooler 20 that is connected to the separator 17 via a pipe (not depicted) and cools the oil, and an oil filter (not depicted) that removes impurities from the oil.

The compressed air separated by the separator 17 is supplied to the outside of the compressor via a compressed air system (compressed gas system). The compressed air system has the separation filter 18 that is connected to the separator 17 and performs secondary separation of the oil from the compressed air, and the aftercooler 21 that is connected to the separation filter 18 via a pipe (not depicted) and cools the compressed air.

For example, the cooling fan 19 is a turbo-type cooling fan, and is arranged on a side of the electric motor 13 such that the axial direction of the cooling fan 19 lies in the horizontal direction (the left-right direction in FIG. 1 and FIG. 3) and crosses the axial direction of the electric motor 13 (becomes orthogonal to the axial direction of the electric motor 13 in the present embodiment). Then, the cooling fan 19 induces a flow of cooling air in the housing 1. Explaining specifically, the cooling air flows into the machine room 11 via the cooling air inlet 8 from the outside of the housing 1, thereafter flows around the electric motor 13 as represented by arrows A, B, and C in FIG. 1, thereafter flows into the fan duct 12 via the vent 22 of the partition plate 10, thereafter flows to the oil cooler 20 and the aftercooler 21, and thereafter flows out to the outside of the housing 1 via the cooling air outlet 9.

Here, a significant feature of the present embodiment is that the cooling fan 19 is configured such that its diameter is greater than the height dimension of the electric motor 13. In addition, the cooling fan 19 is arranged such that its axial-direction projection plane includes a portion overlapping the electric motor 13, a portion positioned above the electric motor 13 and not overlapping the electric motor 13, and a portion positioned below the electric motor 13 and not overlapping the electric motor 13 (see FIG. 2).

Due to the configuration and arrangement of the cooling fan 19 mentioned above, it is possible to increase both the flow rate of cooling air flowing along an upper portion of the electric motor 13 as represented by the arrow A in FIG. 1, and the flow rate of cooling air flowing along a lower portion of the electric motor 13 as represented by the arrow B in FIG. 1. Therefore, the coolability of the electric motor 13 can be enhanced. In addition, due to the size increase of the cooling fan 19, the rotation speed of the cooling fan 19 for attaining a desired air volume can be lowered. Therefore, noise of the cooling fan 19 can be reduced.

In addition, in the present embodiment, the cooling air inlet 8 is arranged such that its vertical-direction projection plane overlaps the electric motor 13, and additionally its lower edge is positioned below the lowest point of the electric motor 13. Accordingly, it is possible to increase also the flow rate of cooling air flowing apart from the lower portion of the electric motor 13 as represented by the arrow C in FIG. 1. Therefore, it is possible to reduce the temperature of cooling air supplied to the oil cooler 20 and the aftercooler 21, and enhance the coolability of the oil cooler 20 and the aftercooler 21.

In addition, in the present embodiment, the electric motor 13 is configured such that the sum total (L1+L2) of an axial dimension L1 between a load-side end surface of a core 24a of the rotor 24 (or a core 25a of the stator 25) and a load-side end of the fins 31, and an axial dimension L2 between a non-load-side end surface of the core 24a of the rotor 24 (or the core 25a of the stator 25) and a non-load-side end of the fins 31 is longer than an axial dimension L3 of the core 24a of the rotor 24 (or the core 25a of the stator 25). Thereby, an axial dimension L of the fins 31 can be increased, and this in turn can increase the surface area of the electric motor 13 cooled by cooling air, and enhance the coolability of the electric motor 13. Furthermore, variations of the temperature of the electric motor 13 in the axial direction of the electric motor 13 can be reduced. Accordingly, variations of the temperature of cooling air that flows around the electric motor 13 and is supplied to the oil cooler 20 and the aftercooler 21 can be reduced, and the cooling efficiency of the oil cooler 20 and the aftercooler 21 can be enhanced.

Note that whereas the electric motor 13 is configured such that the axial dimension L1 between the load-side end surface of the core 24a of the rotor 24 (or the core 25a of the stator 25) and the load-side end of the fins 31 is the same as the axial dimension L2 between the non-load-side end surface of the core 24a of the rotor 24 (or the core 25a of the stator 25) and the non-load-side end of the fins 31 in the case depicted as an example in the first embodiment, this is not the sole example.

The electric motor 13 may be configured such that the axial dimension L1 between the load-side end surface of the core 24a of the rotor 24 (or the core 25a of the stator 25) and the load-side end of the fins 31 is longer than the axial dimension L2 between the non-load-side end surface of the core 24a of the rotor 24 (or the core a of the stator 25) and the non-load-side end of the fins 31. Thereby, thermal effects from the compressor body 14 to the electric motor 13 may be reduced. In particular, if compression chambers of the compressor body 14 are configured so as to move in a direction to approach the electric motor 13 (the leftward direction in FIG. 2, and the upward direction in FIG. 3 and FIG. 4), the delivery side (high-temperature side) of the compressor body 14 is closer to the electric motor 13, and therefore the advantage mentioned before becomes more noticeable.

Alternatively, the electric motor 13 may be configured such that the axial dimension L1 between the load-side end surface of the core 24a of the rotor 24 (or the core 25a of the stator 25) and the load-side end of the fins 31 is shorter than the axial dimension L2 between the non-load-side end surface of the core 24a of the rotor 24 (or the core a of the stator 25) and the non-load-side end of the fins 31. Thereby, mechanical loss of the rotation shaft 23 may be reduced.

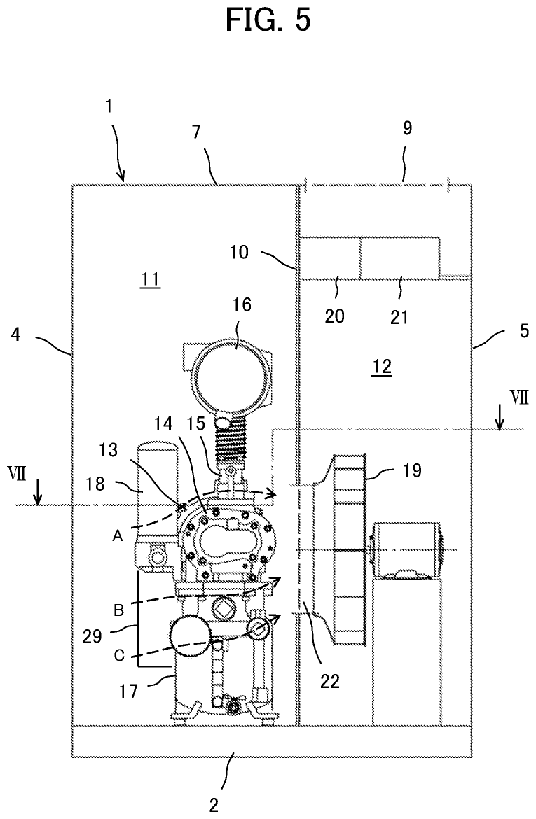

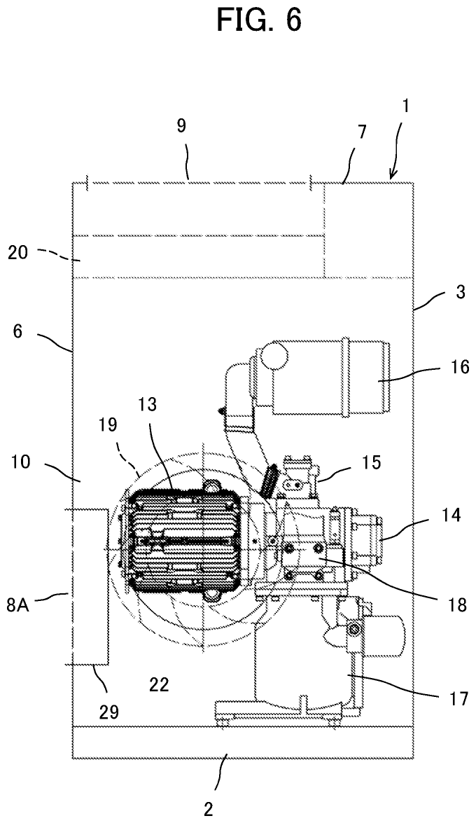

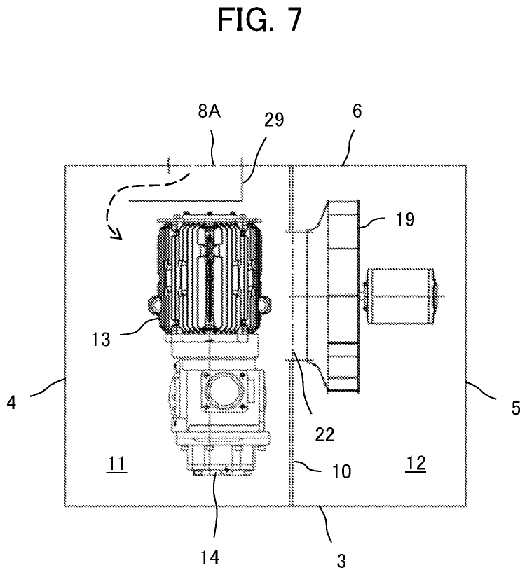

A second embodiment of the present invention is explained by using FIG. 5 to FIG. 7. FIG. 5 is a front-side transparent view representing the structure of main portions of a packaged compressor according to the present embodiment. FIG. 6 is a left-side transparent view representing the structure of main portions of the packaged compressor according to the present embodiment. FIG. 7 is a cross-sectional view taken along a plane represented by arrows VII-VII in FIG. 1. Note that portions in the present embodiment having their counterparts in the first embodiment are given identical reference characters, and explanations thereof are omitted as appropriate.

In the present embodiment, instead of the cooling air inlet 8 of the left side plate 4, a cooling air inlet 8A of the rear side plate 6 is formed. The cooling air inlet 8A of the rear side plate 6 is closer to the electric motor 13 as compared to the cooling air inlet 8 of the left side plate 4. Accordingly, noise of the electric motor 13 may leak to the outside of the housing 1 via the cooling air inlet 8A.

In the present embodiment, an inlet duct 29 that is arranged such that it covers the cooling air inlet 8A, and guides cooling air from the cooling air inlet 8A to the electric motor 13 (specifically, a side of the electric motor 13 which is opposite to the cooling fan 19) is provided. Thereby, leakage of noise of the electric motor 13 to the outside of the housing 1 can be reduced.

In the present embodiment also, the coolability of the electric motor 13 can be enhanced due to the configuration and arrangement of the cooling fan 19 that are similar to those in the first embodiment. In addition, noise of the cooling fan 19 can be reduced. In addition, due to the arrangement of the cooling air inlet 8A similar to that in the first embodiment, the coolability of the oil cooler 20 and the aftercooler 21 can be enhanced.

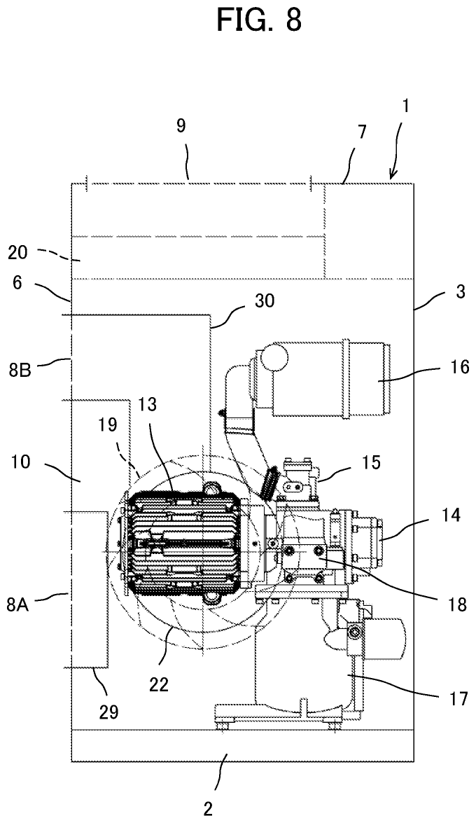

Note that whereas a side surface of the housing 1 has only the cooling air inlet 8 or 8A that is arranged so as to overlap the electric motor 13 when seen in a direction perpendicular to the side surface in the cases explained as examples in the first and second embodiments, this is not the sole example. For example, as in a modification example depicted in FIG. 8, a side surface of the housing 1 may have a cooling air inlet 8B arranged so as not to overlap the electric motor 13 when seen in a direction perpendicular to the side surface. Then, a guidance duct 30 that guides cooling air from the cooling air inlet 8B to the electric motor 13 may be provided.

In addition, whereas the packaged compressor is an oil-supply-type packaged compressor (i.e. the compressor body 14 injects an oil into compression chambers, and the separator 17 separates the oil from a compressed gas) in the cases explained as examples in the first and second embodiments, this is not the sole example, and the packaged compressor may be another liquid-supply-type packaged compressor. That is, the compressor body 14 may inject a liquid such as water into compression chambers, and the separator 17 may separate the liquid such as water from compressed gas.

In addition, whereas the compressor body 14 is a screw-type compressor body, and includes a pair of female and male screw rotors in the cases explained as examples in the first and second embodiments, this is not the sole example. For example, the compressor body may include one screw rotor and a plurality of gate rotors. In addition, the compressor body may be another non-screw-type compressor body.

### DESCRIPTION OF REFERENCE CHARACTERS

1: Housing
8, 8A, 8B: Cooling air inlet
9: Cooling air outlet
13: Electric motor
14: Compressor body
17: Separator
19: Cooling fan
29: Inlet duct
31: Fin

1. A packaged compressor comprising:
an electric motor having an axial direction that lies in a horizontal direction;
a compressor body that is driven by the electric motor and compresses a gas;
a housing that houses the electric motor and the compressor body;
a cooling air inlet formed through a side surface of the housing;
a cooling air outlet formed through an upper surface of the housing; and
a cooling fan that is arranged on a side of the electric motor such that an axial direction of the cooling fan lies in a horizontal direction and crosses the axial direction of the electric motor,
the cooling fan inducing a flow of cooling air that flows in from an outside of the housing via the cooling air inlet, thereafter flows around the electric motor, and thereafter flows out to the outside of the housing via the cooling air outlet, wherein
the cooling fan
is configured such that a diameter of the cooling fan is greater than a height dimension of the electric motor, and additionally
is arranged such that an axial-direction projection plane of the cooling fan includes a portion overlapping the electric motor, a portion positioned above the electric motor and not overlapping the electric motor, and a portion positioned below the electric motor and not overlapping the electric motor.

2. The packaged compressor according to claim 1, wherein
the cooling air inlet is arranged such that a vertical-direction projection plane of the cooling air inlet overlaps the electric motor.

3. The packaged compressor according to claim 2, wherein
the packaged compressor includes a separator that separates a liquid from a compressed gas delivered from the compressor body,
the compressor body is coupled to one axial side of the electric motor,
the separator is coupled to a lower side of the compressor body, and
the cooling air inlet is arranged such that the vertical-direction projection plane of the cooling air inlet overlaps the electric motor, and additionally a lower edge of the cooling air inlet is positioned below a lowest point of the electric motor.

4. The packaged compressor according to claim 2, wherein
the packaged compressor includes an inlet duct that is arranged so as to cover the cooling air inlet and guides the cooling air from the cooling air inlet to the electric motor.

5. The packaged compressor according to claim 1, wherein
the electric motor
includes: a rotation shaft; a rotor attached to the rotation shaft; a stator arranged apart from and on an outer-circumference side of the rotor; a casing to which the stator is attached; and a plurality of fins that are formed outside the casing and extend in the axial direction, and additionally
is configured such that a sum total (L1+L2) of an axial dimension L1 between a load-side end surface of a core of the rotor or a core of the stator and a load-side end of the fins, and an axial dimension L2 between a non-load-side end surface of the core of the rotor or the core of the stator and a non-load-side end of the fins is longer than an axial dimension L3 of the core of the rotor or the core of the stator.

6. The packaged compressor according to claim 5, wherein
the electric motor
is configured such that the axial dimension L1 between the load-side end surface of the core of the rotor or the core of the stator and the load-side end of the fins is longer than the axial dimension L2 between the non-load-side end surface of the core of the rotor or the core of the stator and the non-load-side end of the fins.

7. The packaged compressor according to claim 5, wherein
the electric motor
is configured such that the axial dimension L1 between the load-side end surface of the core of the rotor or the core of the stator and the load-side end of the fins is shorter than the axial dimension L2 between the non-load-side end surface of the core of the rotor or the core of the stator and the non-load-side end of the fins.

8. A compressor unit comprising: an electric motor; and a compressor body that is coupled to one axial side of the electric motor and driven by the electric motor to compress a gas, wherein
the electric motor
includes: a rotation shaft coupled to a rotor of the compressor body; a rotor attached to the rotation shaft; a stator arranged apart from and on an outer-circumference side of the rotor; a casing to which the stator is attached; and a plurality of fins that are formed outside the casing and extend in an axial direction, and additionally
is configured such that a sum total (L1+L2) of an axial dimension L1 between a load-side end surface of a core of the rotor or a core of the stator and a load-side end of the fins, and an axial dimension L2 between a non-load-side end surface of the core of the rotor or the core of the stator and a non-load-side end of the fins is longer than an axial dimension L3 of the core of the rotor or the core of the stator.
